(19) United States
(12) Patent Application Publication
(10) Pub. No.: US 2002/0108477 A1
(43) Pub. Date: Aug. 15, 2002

(54) Method for cutting coating blankets from sheet-type work material

(76) Inventors: Dana W. Seniff, South Glastonbury, CT (US); Wolfgang M. Strobel, Tolland, CT (US)

Correspondence Address: McCormick, Paulding & Huber, City Place II, 185 Asylum Street, Hartford, CT, 06103-3402, US

(21) Appl. No.: 10/068,685

(22) Filed: Feb. 5, 2002

Related U.S. Application Data
(60) Provisional application No. 60/267,661, filed on Feb. 9, 2001.

(51) Int. Cl. B26D 5/00

(52) U.S. Cl. 83/34; 83/35; 83/39; 83/74; 83/76.9

(57) ABSTRACT

A method for creating a coating blanket for use in printing presses includes providing a sheet of work material having a laminated construction wherein a flexible layer is coupled to a carrier layer of semi-rigid material. A cutting apparatus employing a drag-type knife movable between a working and non-working position is employed to cut the coating blanket from the coating blanket material. A controller having graphic cutting data and carrier layer cutting data stored therein generates command signals to operate the cutting apparatus, causing the flexible layer of coating blanket material to be cut in a single pass in accordance with said graphic cutting data and the carrier layer of coating blanket material to be cut via multiple passes of the knife in accordance with the carrier layer cutting data.

### Cross Reference to Related Applications

This application is entitled to the benefit of, and incorporates by reference, essential subject matter disclosed in Provisional Patent Application Serial No. 60/267,661 filed on Feb. 9, 2001.

### FIELD OF THE PRESENT INVENTION

The present invention is generally directed to coating blankets for use on printing presses and more specifically to a method for cutting a coating blanket from a piece of layered sheet-type work material.

### BACKGROUND OF THE PRESENT INVENTION

Coating blankets are used to transfer inks, washes, varnishes and like substances used in printing operations onto print media such as paper or cardboard. In general, the coating blanket is made from sheet-type work material having at least two layers. Where a graphic is to be printed, one of the layers of material is cut to conform to the desired graphic while the other layer acts as a carrier. The coating blanket is usually mounted via the carrier layer onto a rotatable drum forming part of a printing press. During a printing operation, the print media is fed under and in engagement with the drum, causing the substance coated onto the drum to be transferred to the print media.

A difficulty that often occurs is due to the fact that the printing presses provided by different manufacturers employ differently sized drums which in turn means differently sized coating blankets. Accordingly, a printer having several printing presses made by different manufacturers must stock several different sizes of coating blanket material.

During the fabrication process, coating blankets are typically cut to incorporate the desired graphics thereon by employing a cutting apparatus wherein a knife selectively slices through the first layer of coating blanket material. The cut areas are then weeded or removed from the coating blanket. These cutting apparatus generally employ what is referred to by those skilled in the pertinent art to which the present invention pertains, as a “drag knife.” A drag knife consists of a cuffing blade mounted in bearings that allow the knife to swivel as it is moved in engagement with the coating blanket material. The knife and bearings are usually mounted to a cutter head that in turn is mounted to a support, both of which can move relative to the coating blanket material, typically carried on a support surface forming part of the cutting apparatus. The depth at which the knife extends into the coating blanket material has historically been preset such that during a cuffing operation, the blade extends a known distance past a surface that engages the coating blanket material during a cutting operation.

One problem associated with cutting apparatus configured in the above-described manner is that the layer of coating blanket material being cut by the knife can be non-uniform in thickness. Since the penetration depth of the knife is set so as to cut through the first layer of coating blanket material with minimal scoring to the second or carrier layer of material, non-uniform thickness in the first layer will result in the knife not cutting through the layer or cutting too deeply. Another problem that occurs is the above-described cutting apparatus usually do not account for dulling or breaking of the knife tip, which also results in areas of the coating blanket not being cut through as desired.

Based on the foregoing, it is a generally object of the present invention to provide a method for cutting a coating blanket from sheet-type work material that overcomes the drawbacks and problems associated with prior art methods.

It is a more specific object of the present invention to provide a method for cutting a coating blanket material from sheet-type work material whereby it becomes unnecessary for a printer to stock different sizes of sheet material, and wherein the cutting apparatus compensates for non-uniform thickness of the first layer of coating blanket material.

### SUMMARY OF THE PRESENT INVENTION

The present invention is directed in one aspect to a method for creating a coating blanket for use in a printing press wherein sheet-type work material having a laminated construction wherein a layer of flexible material is coupled to a carrier layer of semi-rigid material is presented to a cutting apparatus. In the preferred embodiment of the present invention, the cutting apparatus includes a cutting surface and drive means for moving the work material relative to the cutting surface in response to command signals generated by a controller coupled to the cutting apparatus. A cutter head having a cutting blade coupled thereto is positioned adjacent to the cutting surface for movement thereacross in response to the command signals. The cutting blade is positionable, via the cutter head, between a non-working position wherein the cutting blade is located adjacent the work material, and a working position wherein the cutting blade engages the work material.

The controller is programmed with graphic cutting data and carrier layer cuffing data, and the work material is presented to the cutting apparatus with the carrier layer thereof engaging the cutting surface. During a cutting operation, the drive means moves the coating blanket material back and forth over the cutting surface in response to the command signals generated by the controller. As this occurs, the cutter head, responsive to said graphic cutting data, causes the cutting blade to move between the non-working and working positions to selectively cut through portions of the flexible layer in a single pass. In addition, the cutting blade engages the carrier layer making multiple cutting passes along lines defining the periphery of the coating blanket in response to command signals issued from the controller in accordance with the carrier layer cutting data, thereby selectively cutting through portions of the carrier layer.

Preferably, the cutting apparatus includes a reference surface for providing the controller with datum information regarding the location of a tip portion of the cutting blade. Prior to, and in some cases during, a cutting operation, the blade is moved in accordance with command signals generated by the controller such that the tip portion thereof touches the reference surface located on said cutting apparatus. The vertical distance the blade must be moved so that the tip portion engages the reference surface is sensed and stored in the controller. Based on this stored location, the flexible layer and carrier layer cutting data are adjusted to allow for proper knife penetration. Alternatively, the pressure exerted by the knife on the work material can be measured and used to control the cutting depth during a cutting operation.

In the preferred embodiment of the present invention, the cutting apparatus includes a frame with the cutting surface being defined by a roller coupled for rotation to the frame. The above-described cutter head is movable along a longitudinal direction defined by the roller in response to the command signals generated by the controller. During a cutting operation, the carrier layer, which is generally semi-rigid and somewhat difficult to cut, is cut to define the periphery of the coating blanket. This operation is accomplished via multiple passes of the cutting blade in accordance with the carrier layer cutting data stored in the controller. To prevent the coating blanket from prematurely separating from the work material, a plurality of spaced-apart slits are cut into the carrier layer, each along a first pair of opposing edges which in part define the periphery of the coating blanket. The first pair of opposed lateral edges are approximately perpendicular to a longitudinal axis defined by the roller. Once the slits along the first pair of opposed edges have been cut, a plurality of second spaced apart slits extending through the carrier layer are cut along a second pair of spaced apart opposing edges approximately parallel to the roller axis. The first and second pairs of opposing edges together define the periphery of the coating blanket. By cutting the carrier layer in this manner, the second spaced apart slits allow the work material to overhang the roller as it is advanced thereover without the semirigid nature of the carrier layer causing the coating blanket to separate from the work material.

Preferably, once the coating blanket has been cut and separated from the work material, the mounting holes or slots unique to the particular printing press upon which the coating blanket will be used, are cut into the coating blanket. Fabricating coating blankets in the above-described manner has the advantage of allowing a printer to stock a single size of work material. In addition, because the carrier layer is cut via multiple passes of the knife, a less expensive cutting apparatus, e.g. one that does not require the capability and stiffness necessary to cut through the carrier layer in a single pass, can be employed.

### BRIEF DESCRIPTION OF THE DRAWINGS

FIG. 1 is a perspective view of a cutting apparatus useful in practicing the method of the present invention.

FIG. 2 is a partial side elevational view of the coating blanket material of the present invention showing the first layer of flexible material and the second layer of semi-rigid material.

FIG. 3 is a plan view of an embodiment of the coating blanket material of FIG. 2 showing opposed lateral edges defined by the second layer of semi-rigid material FIG. 4 is a partial cross sectional view of the apparatus of FIG. 1 showing one of a pair of drive sprockets engaging apertures extending through lateral edge portions defined by the second layer of semi-rigid material.

FIG. 5 is a partial view of the coating blanket material of FIG. 2 showing the preferred carrier layer cutting pattern.

### DETAILED DESCRIPTION OF THE PREFERRED EMBODIMENT

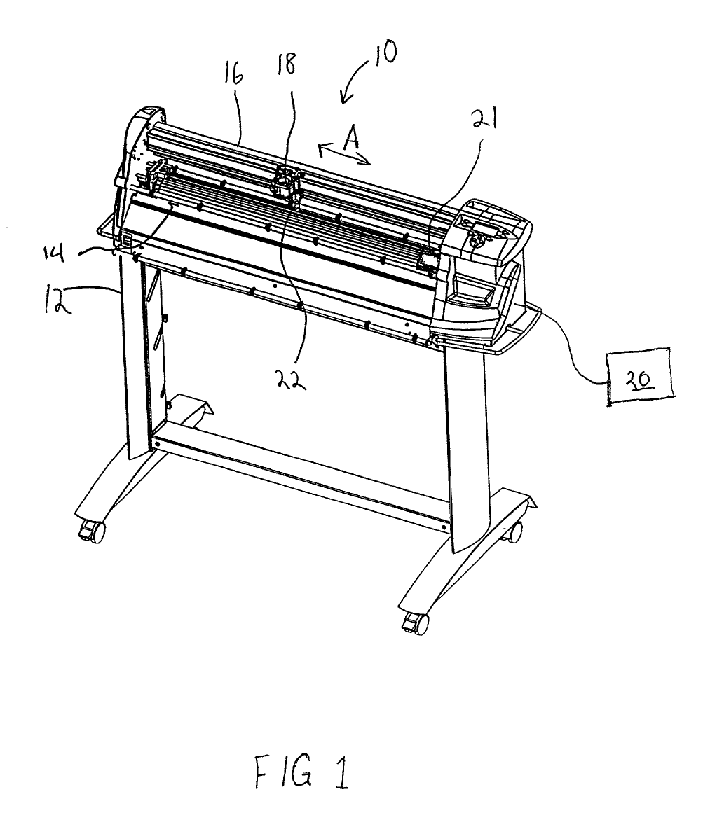

As shown in FIG. 1, a cutting apparatus generally designated by the reference number 10 includes a frame 12 having a cutting surface 14 mounted thereon. The cutting surface 14 extends across the frame 12 and, as will be explained in detail below, is adapted to support a sheet of coating blanket material. A support 16 is also mounted to the frame 12 and is adjacent and approximately perpendicular to the cutting surface 14. A cutter head 18 is mounted to the support 16 for movement back and forth along the support as indicated by the arrows labeled “A” in response to commands issued from a controller 20 in communication with the cutting apparatus 10 and having coating blanket cutting data stored therein in a machine readable format. A knife 22 is pivotally mounted to the cutter head 18 and is movable, responsive to said coating blanket cutting data, between a working position wherein said knife engages and cuts said coating blanket material, and a non-working position wherein said knife is positioned above and adjacent said coating blanket material. In the preferred embodiment of the present invention, the knife 22 is a drag-type knife that pivots while in the working position, in response to a change in cutting direction to reorient the knife along the direction of cut. A reference surface 21, the operation of which will be explained in detail below, is also provided on the frame 12 adjacent to the cutting surface 14.

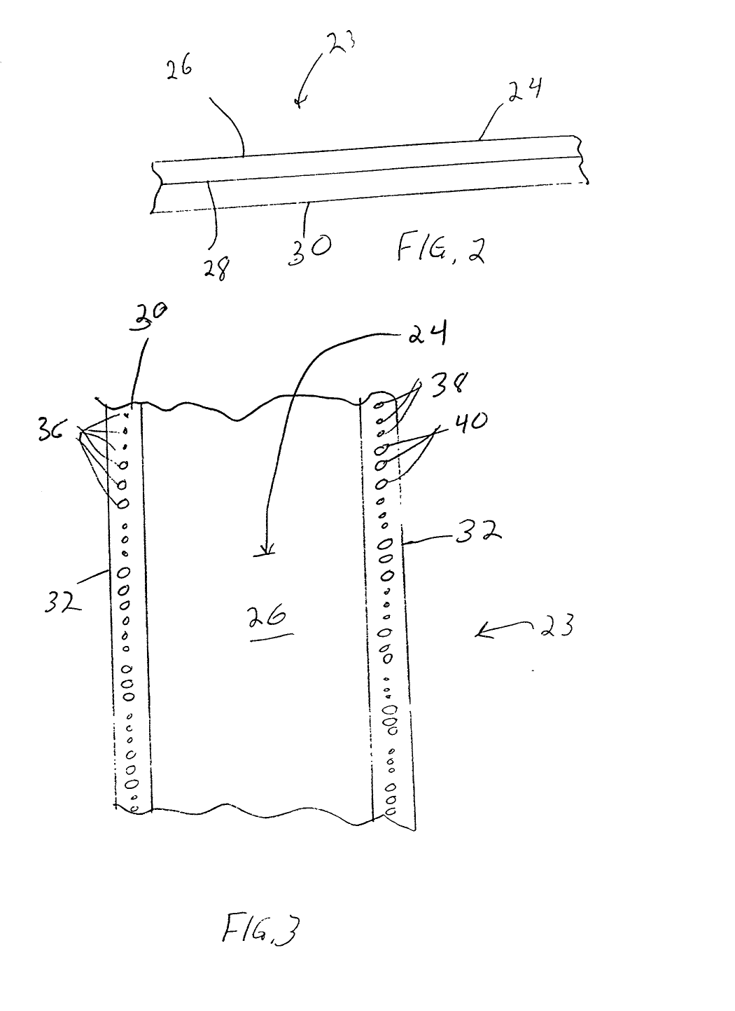

As shown in FIG. 2, the coating blanket material 23 includes a first layer of flexible material 24 having an upper surface 26 and a lower surface 28. Preferably, the first layer is formed from a suitable material such as, but not limited to, polyurethane. A carrier layer 30 of semi-rigid polymeric material is bonded via an adhesive to the lower surface 28 of the first layer 24, thereby forming a laminate. Preferably, the adhesive employed allows the first layer 24 to be peeled from the second layer, with the carrier layer having such release characteristics that substantially all of the adhesive remains bonded to the lower surface 28 of the first layer of flexible material; however, the present invention is not limited in this regard. In the preferred embodiment of the present invention, the carrier layer 30 is formed from a polymer, such as, but not limited to, polyester.

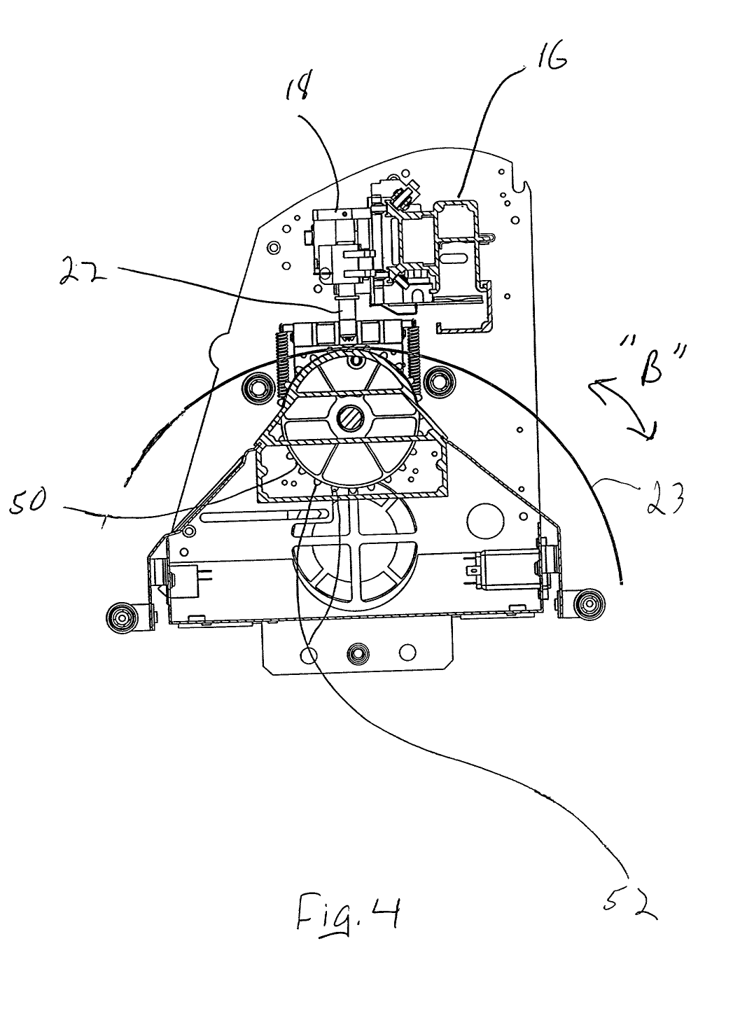

Turning to FIG. 3, an embodiment of the above-described coating blanket material includes a pair of opposing lateral edge portions 32 defined by the second layer 30 of semi-rigid polymeric material. Each lateral edge portion 32 extends outwardly from a corresponding edge portion 34 of the first layer of flexible material 24 and defines a plurality of apertures generally designated by the reference numeral 36 extending therethrough. Each aperture 36 in one of said lateral edge portions 32 is approximately aligned with a corresponding aperture in the other of said lateral edge portions. In the illustrated embodiment of the present invention, the apertures are positioned in a repeating pattern of a first series of smaller apertures 38 followed by a second series of larger apertures 40. The reasons for and the use of these apertures will be explained in detail below.

Referring to FIG. 4, a pair of drive sprockets 50 (only one shown) is rotatably mounted to the frame 12, each adjacent to a respective end of the cutting surface 14. At least one of the drive sprockets 50 is coupled to a suitable drive (not shown) such as, but not limited to, a stepper motor or servo responsive to commands issued from the controller 20 for angularly rotating the sprocket 50 back and forth in a first and second angular direction, the second angular direction being generally opposite to the first angular direction, as indicated by the arrow labeled “B”. Each of the drive sprockets 50 define a plurality of radially extending drive pins 52 adapted to engage the apertures 36 defined by the opposed lateral edge portions 32 of the second layer of semi-rigid material 30. The drive pins 52 can vary in size and be arranged in a pattern to conform to the aperture pattern defined by the opposed lateral edge portions of the second layer of semi-rigid material shown in FIG. 3. While a particular aperture and drive pin pattern has been illustrated, the present invention is not limited in this regard as any number of different aperture and drive pin patterns can be employed without departing from the broader aspects of the present invention.

Prior to operation, the coating blanket cutting data is stored in the controller 20 in the form of graphic cutting data and carrier layer cutting data. Referring back to FIG. 1, the reference surface 21 is used both prior to and during a cutting operation to establish a datum point for the tip portion of the knife 22.

Accordingly, in response to commands issued from the controller 20, the cutter head 18 causes the knife to be positioned over the reference surface 21, and the knife is moved toward the working position until such time as the tip portion of the knife touches the reference surface. This location is then sensed by either sensors on or adjacent to the reference surface (not shown) or by an optical encoder (not shown) positioned in the cutting head 18. This sensor reference point allows for precise cutting depth control during a cutting operation. Periodically during operation, the tip portion of the knife can also be touched to the reference surface to evaluate knife wear and to ensure that the tip portion has not become broken off. The location of the knife can then be subsequently adjusted to ensure that the proper cuts are made in the coating blanket. Alternatively, the depth at which the knife cuts can be controlled during a cutting operation via the pressure exerted on or against the knife. In this case, a pressure sensor (not shown) can be positioned in the cutter head or elsewhere and a predetermined pressure applied to the knife, the pressure being sufficient to cause the knife to perform the desired cutting operation.

During operation, the coating blanket material 23 is loaded into the cuffing apparatus 10 by aligning the apertures 36 defined by the lateral edge portions 32 of the second layer of semi-rigid material with the drive pins 52 extending from each of the above-described drive sprockets 50. In response to commands issued from the controller in accordance with the coating blanket cutting data stored therein, the drive sprockets 50 move the coating blanket material 23 back and forth in the first and second directions as indicated by the arrow B. As the coating blanket material is being moved by the drive sprocket 50, the cutter head 18, also in response to commands issued from the controller 20, traverses back and forth along the support. As the cutter head and coating blanket material move relative to one another, a graphic is generally cut into the coating blanket material by cutting through the flexible layer 24 completely without cutting into the carrier layer 30. The flexible layer 24 is cut via a single pass of the drag knife 22.

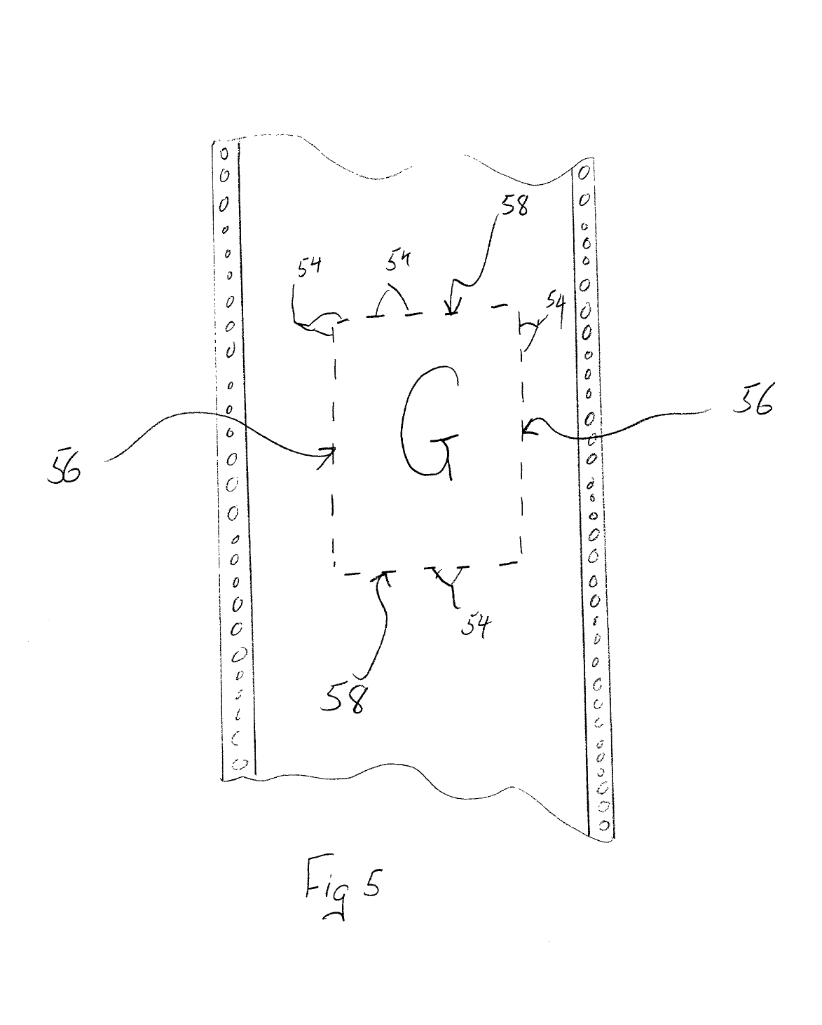

As shown in FIG. 5, the carrier layer is cut to conform to the desired peripheral size and shape of the finished coating blanket. Since the carrier layer 30 is somewhat rigid, the knife cuts through it by way of multiple passes over the same line of cut. In order to prevent the coating blanket from separating from the coating blanket material, rather than cutting a sustained line, intermittent slits 54 are cut into the carrier layer, providing for easy separation of the coating blanket from the coating blanket material upon removal from the cutting apparatus 10. These intermittent slits 54 are cut around the periphery of the coating blanket in a particular order. Initially, a first pair of opposed lateral edges 56 that are spaced apart relative to one another and extend approximately perpendicular to a longitudinal axis defined by the cutting apparatus roller are cut. Upon completion of the cutting operation, with respect to the first pair of lateral edges 56, a second pair of lateral edges 58, which together with the first pair of lateral edges coact to define the periphery of the coating blanket, are cut in much the same way with a plurality of intermittent slits being cut through the carrier layer 30 along each of the edges comprising the second pair of lateral edges. The second pair of lateral edges extend approximately parallel to the longitudinal roller axis and are cut after the first pair of lateral edges to prevent the coating blanket from separating from the coating blanket material due to the bowing of the material as it is fed through the cutting apparatus 10 as shown in FIG. 4.

Upon completion of the cutting operation, the coating blanket material is then removed from the cutting apparatus 10, and the coating blanket separated along the intermittent slits in the first and second pairs of opposed lateral edges. Once separated, the coating blanket can then be punched or otherwise cut in accordance with a mounting pin pattern unique to a rotating drum on a printing press (not shown) upon which the coating blanket will be mounted. While the above-described embodiments of the present invention have incorporated a sprocket-type drive system for moving the coating blanket material 23 back and forth through the cutting apparatus 10, the present invention is not limited in this regard. Other types of drive systems known to those skilled in the pertinent art to which the invention pertains, such as a friction or grit wheel-type drive, can be employed without departing from the broader aspects of the present invention.

It is to be understood that the form of the invention shown and described herein is to be taken as a preferred embodiment of the same, and that various changes in the selection of parts comprising the broadly defined means and in the arrangement of said parts may be resorted to without departing from the spirit of the invention or the scope of the following claims.

What is claimed is:

1. A method for creating a coating blanket for use in a printing press, comprising the steps of:
providing sheet-type work material having a laminated construction wherein a layer of flexible material is coupled to a carrier layer of semi-rigid material;
providing a cutting apparatus having a cutting surface, drive means for moving said work material relative to said cuffing surface in response to command signals generated by a controller coupled to said cuffing apparatus, a cutter head positioned adjacent to said cutting surface for movement thereacross in response to said command signals, a cutting blade coupled to said cutter head, said cutting blade being positionable, via said cutter head, between a non-working position wherein the cutting blade is located adjacent said work material, and a working position wherein said cutting blade engages said work material;
programming said controller with graphic cutting data and carrier layer cuffing data;
presenting said coating blanket material to said cutting apparatus such that said carrier layer engages said cuffing surface;
causing said drive means to move said coating blanket material back and forth over said cutting surface in response to said command signals issued from said controller;
moving said cutter head, responsive to said graphic cutting data relative to said cuffing surface, and said cutting blade between said non-working and working positions to selectively cut through portions of said flexible layer in a single pass during a cutting operation;
causing said blade to engage said carrier layer and make multiple cutting passes along lines of cut defined by command signals issued from said controller in accordance with said carrier layer cutting data, thereby selectively cutting through portions of said carrier layer; and
removing said coating blanket material from said cutting apparatus;
separating a coating blanket from said coating blanket material along said lines of cut extending through said carrier layer.

2. A method for making a coating blanket as defined by claim 1, wherein prior to said step of moving said cutter head, responsive to said graphic cutting data relative to said cutting surface, and said cutting blade between said non-working and working positions, said method includes the further step of:
moving said blade in accordance with command signals issued from said controller such that a tip portion thereof touches a reference surface located on said cutting apparatus;
sensing the location of said tip portion and thereby said blade upon touching said reference surface;
storing the sensed location of said cutting blade and tip portion relative to said reference surface, in said controller; and wherein during said step of moving said cutting blade between said non-working and working positions, said method includes the further step of adjusting an amount by which said tip portion of said cutting blade extends into said work material in accordance with said sensed location.

3. A method for creating a coating blanket as defined by claim 1, wherein:
said cutting apparatus further includes a frame and said cutting surface is defined by a roller coupled for rotation to said frame, said cutter head being movable along a longitudinal direction defined by said roller in response to said command signals issued from said controller; and wherein said step of causing said blade to engage said carrier layer further includes creating via multiple passes of said cutting blade, and in accordance with said carrier sheet cutting data, a plurality of first spaced apart slits extending through said carrier layer along a first pair of opposing edges which in part define the periphery of said coating blanket, said first pair of opposing edges being approximately perpendicular to a longitudinal axis defined by said roller; and
creating via multiple passes of said cutting blade, and in accordance with said carrier sheet cutting data, a plurality of second spaced apart slits extending through said carrier layer along a second pair of spaced apart opposing edges approximately parallel to said longitudinal axis and approximately perpendicular to said first pair of opposing edges, said first and second pairs of opposing edges together defining the periphery of said coating blanket; and whereby
said second spaced apart slits allow said work material to overhang said roller as it is advanced thereover without the semi-rigid nature of the carrier layer causing said coating blanket to separate from said work material.

4. A method for creating a coating blanket as defined by claim 1, wherein during said steps of moving said cutting blade between said non-working and working positions to selectively cut through portions of said flexible layer, and causing said blade to engage said carrier layer and make multiple cutting passes along lines of cut defined by command signals issued from said controller in accordance with said carrier layer cutting data, thereby selectively cutting through portions of said carrier layer, said method includes the further steps of:
sensing the amount of pressure exerted by said cutting blade in a direction approximately normal to said work material; and
adjusting said pressure to cut through said flexible layer in a single pass, and into said carrier layer a desired amount on each of said multiple cutting passes.

5. A method for creating a coating blanket as defined by claim 3, wherein said first pair of opposed edges each defining areal portions of said carrier sheet positioned between successive slits, and wherein said step of creating via multiple passes of said cutting blade, and in accordance with said carrier sheet cuffing data, a plurality of second spaced apart slits further includes scoring said areal portions via multiple passes of said cuffing blade in accordance with said carrier sheet cutting data.
